(19) United States
(12) Patent Application Publication
(10) Pub. No.: US 2023/0096082 A1
(43) Pub. Date: Mar. 30, 2023

(54) ELECTROCHROMIC DEVICE INCLUDING GRAPHENE ELECTRODES, AND METHOD FOR MAKING THE SAME

(71) Applicant: ELECTRONICS AND TELECOMMUNICATIONS RESEARCH INSTITUTE, Daejeon (KR)

(72) Inventors: Doo-Hee CHO, Daejeon (KR); Tae-Youb KIM, Seoul (KR); Hojun RYU, Seoul (KR); Juhee SONG, Daejeon (KR); Chil Seong AH, Daejeon (KR)

(21) Appl. No.: 17/669,656

(22) Filed: Feb. 11, 2022

(30) Foreign Application Priority Data
Sep. 27, 2021 (KR) 10-2021-0127320

(51) Int. Cl. G02F 1/155

(52) U.S. Cl. CPC G02F 1/155

(57) ABSTRACT

Disclosed are an electrochromic device including graphene electrodes and a method for making the same. An electrochromic device including graphene electrodes according to various example embodiments includes a first multilayer thin film structure connected to a first electrode of an external power source, and including a first graphene layer and a first metal protective layer formed on the first graphene layer to protect the first graphene layer from oxygen, a second multilayer thin film structure connected to a second electrode of the external power source, and including a second graphene layer and a second metal protective layer formed on the second graphene layer to protect the second graphene layer from oxygen, and an electrolyte charged between the first multilayer thin film structure and the second multilayer thin film structure.

### CROSS-REFERENCE TO RELATED APPLICATION

This application claims the benefit of Korean Patent Application No. 10-2021-0127320 filed on Sep. 27, 2021, in the Korean Intellectual Property Office, the entire disclosure of which is incorporated herein by reference for all purposes.

### BACKGROUND

### 1. Field of the Invention

One or more example embodiments relate to an electrochromic device including graphene electrodes and a method for making the same.

### 2. Description of Related Art

A smart window refers to a window that satisfies both sensibility and functions of freely controlling a transmittance of sunlight entering from the outside to reduce energy loss and improve energy efficiency, thereby providing a comfortable environment for users. The smart windows are being applied in various fields such as automobiles, buses, airplanes, trains, etc. as well as in construction fields such as houses and interiors, etc. and information display fields such as displays and semiconductors, etc. using UV blocking characteristics, visible light control function and infrared reflection characteristics. Accordingly, electrochromic devices widely used in the smart windows also get into the spotlight. Electrochromism refers to a phenomenon in which coloring and bleaching occur reversibly by an external electrochemical stimulus. In general, the electrochromism is caused by insertion/extraction processes of electrons and ions (for example, H+ and Li+) in a cathodic coloration material or an anodic coloration material.

The above description is information the inventor(s) acquired during the course of conceiving the present disclosure, or already possessed at the time, and is not necessarily art publicly known before the present application was filed.

### SUMMARY

Graphene is attracting attention as a transparent electrode for electrochromic devices due to its flexibility, extremely thin thickness, and high transmittance in infrared region. The electrochromic devices generally have a structure in which a planar transparent electrode and an electrochromic layer capable of coloring and bleaching are formed on a substrate, and opposite electrodes are installed with an electrolyte interposed therebetween. In addition, a metal oxide thin film such as tungsten oxide is often used as the electrochromic layer. In the case that graphene electrodes are used as the transparent electrode of a metal oxide thin film, if oxygen is used as a process gas in a process of making the metal oxide thin film, graphene may be damaged. Accordingly, it may be required to develop the electrochromic device using the graphene electrodes without damage by oxygen and a technology for making the same.

Various example embodiments may provide the electrochromic device including a graphene layer and a metal protective layer protecting the graphene layer from oxygen.

Various example embodiments may provide a technique for making the electrochromic device including the graphene layer and the metal protective layer protecting the graphene layer from oxygen.

However, technical tasks are not limited to the above-described technical tasks, and other technical tasks may exist.

According to an aspect, there is provided an electrochromic device including a first multilayer thin film structure connected to a first electrode of an external power source and including a first graphene layer and a first metal protective layer formed on the first graphene layer to protect the first graphene layer, a second multilayer thin film structure connected to a second electrode of the external power source and including a second graphene layer and a second metal protective layer formed on the second graphene layer to protect the second graphene layer, and an electrolyte charged between the first multilayer thin film structure and the second multilayer thin film structure.

The first multilayer thin film structure may further include a cathode substrate connected to the first electrode of the external power source and positioned under the first graphene layer and a cathodic coloration layer formed on the first metal protective layer.

The second multilayer thin film structure may further include an anode substrate connected to the second electrode of the external power source and positioned under the second graphene layer and an anodic coloration layer formed on the second metal protective layer.

The first metal protective layer may include a metal having the same component as a part of composition of the cathodic coloration layer, and the second metal protective layer may include a metal having the same component as a part of composition of the anodic coloration layer.

Each of the first multilayer thin film structure and the second multilayer thin film structure may further include a metal mesh having a sheet resistance of 10Ω/□ or less formed under the first graphene layer and under the second graphene layer.

The first graphene layer and the first metal protective layer may be replaced with an opaque metal, or the second graphene layer and the second metal protective layer may be replaced with an opaque metal.

The first graphene layer and the first metal protective layer may be replaced with a transparent conducting oxide (TCO) layer, or the second graphene layer and the second metal protective layer may be replaced with a TCO layer.

One of the cathodic coloration layer and the anodic coloration layer may be replaced with an ion storage layer.

The cathodic coloration layer and the first metal protective layer may be removed, or the anodic coloration layer and the second metal protective layer may be removed.

According to an aspect, there is provided a method of making an electrochromic device using a multilayer thin film structure including a graphene layer may include forming a first multilayer thin film structure connected to a first electrode of an external power source and including a first graphene layer and a first metal protective layer formed on the first graphene layer to protect the first graphene layer, forming a second multilayer thin film structure connected to a second electrode of the external power source and including a second graphene layer and a second metal protective layer formed on the second graphene layer to protect the second graphene layer, and charging an electrolyte between the first multilayer thin film structure and the second multilayer thin film structure.

The forming of the first multilayer thin film structure may include forming the first graphene layer on an cathode substrate connected to the first electrode, forming the first metal protective layer on the first graphene layer using one or more of sputtering, thermal deposition, chemical vapor deposition, and atomic layer deposition and forming a cathodic coloration layer including a metal oxide on the first metal protective layer using one or more of sputtering, thermal deposition, chemical vapor deposition, atomic layer deposition, and heat treatment after wet coating.

The forming of the second multilayer thin film structure may include forming the second graphene layer on an anode substrate opposite the cathode substrate and connected to the second electrode, forming the second metal protective layer on the second graphene layer using one or more of sputtering, thermal deposition, chemical vapor deposition, and atomic layer deposition, and forming an anodic coloration layer including the metal oxide on the second metal protective layer using one or more of sputtering, thermal deposition, chemical vapor deposition, atomic layer deposition, and heat treatment after wet coating.

The method may further include forming a metal mesh having the sheet resistance of 10Ω/□ or less formed under the first graphene layer and the second graphene layer.

The first graphene layer and the first metal protective layer may be replaced with an opaque metal, or the second graphene layer and the second metal protective layer may be replaced with an opaque metal.

The first graphene layer and the first metal protective layer may be replaced with a transparent conducting oxide (TCO) layer, or the second graphene layer and the second metal protective layer may be replaced with a TCO layer.

One of the cathodic coloration layer and the anodic coloration layer may be replaced with an ion storage layer.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating an electrochromic device;

FIG. 2 is a diagram illustrating an electrochromic device according to various example embodiments;

FIG. 3 is a diagram illustrating examples in which an electrochromic device is modified according to various example embodiments;

FIG. 4 is a diagram illustrating another example in which an electrochromic device is modified according to various example embodiments;

FIG. 5 is a diagram illustrating another example in which an electrochromic device is modified according to various example embodiments;

FIG. 6 is a diagram illustrating another example in which an electrochromic device is modified according to various example embodiments;

FIG. 7 is a diagram illustrating another example in which an electrochromic device is modified according to various example embodiments;

FIG. 8 is a diagram illustrating a light transmittance of the multilayer thin film structure shown in FIG. 2 according to various example embodiments;

FIG. 9 is a diagram illustrating conductivity and electrochromic effect of the multilayer thin film structure shown in FIG. 2 according to various example embodiments; and

FIG. 10 is a flowchart illustrating an example of a method of making an electrochromic device according to various example embodiments.

### DETAILED DESCRIPTION

Specific structural or functional descriptions of example embodiments are disclosed merely for the purpose of illustration, and may be changed and implemented in various forms. Accordingly, actual implementations are not limited to specific example embodiments disclosed, and the scope of the present specification includes changes, equivalents, or substitutes included in the technical ideas described as example embodiments.

Although terms such as first or second may be used to describe various components, these terms should be interpreted only for purpose of distinguishing one component from another. For example, a first component may be termed a second component, and similarly, the second component may also be termed the first component.

When a component is referred to as being “connected” to another component, the component may be directly connected or accessed to the other component, but it should be understood that another component may exist in between.

A singular expression includes a plural expression unless a context clearly dictates otherwise. In the present specification, it should be understood that terms such as “comprise”, “include” or “have” are intended to designate presence of described feature, number, step, process, component, part, or combination thereof, and do not preclude possibility of addition or existence of one or more other features, numbers, steps, processes, components, parts, or combinations thereof.

Unless defined otherwise, all terms used herein, including technical or scientific terms, have the same meaning as commonly understood by a person skilled in the art. Terms such as those defined in commonly used dictionaries should be interpreted as having a meaning consistent with the meaning in the context of the related art, and should not be interpreted in an ideal or excessively formal meaning unless explicitly defined in the present specification.

Hereinafter, example embodiments will be described in detail with reference to the accompanying diagrams. In description with reference to the accompanying diagrams, the same components are assigned the same reference numerals regardless of diagram numerals, and overlapping descriptions thereof will be omitted.

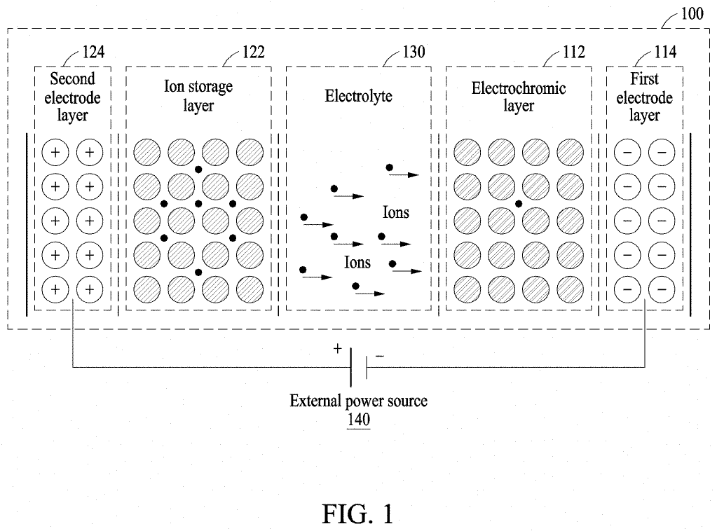

FIG. 1 is a diagram illustrating an electrochromic device.

Referring to FIG. 1, a electrochromic device 100 may include an electrochromic layer 112, a first electrode layer 114, an ion storage layer 122, a second electrode layer 124, and an electrolyte 130. The electrochromic device 100 may be connected to an external power source 140. The first electrode layer 114 may be connected to a cathode of the external power source 140 to form the electrochromic layer 112 on the first electrode layer 114, and the second electrode layer 124 opposite the first electrode layer 114 may be connected to an anode of the external power source 140 to form the ion storage layer 122 on the second electrode layer 124. The electrolyte 130 may be charged between the opposite two electrode layers, the first electrode layer 114 and the second electrode layer 124.

The electrochromic layer 112 may include a cathodic coloration transition metal oxide, which is a cathodic coloration material that exhibits electrochromism. When a voltage is input, the cathodic coloration transition metal oxide is a material that is colored as a cation is inserted into the cathodic coloration transition metal oxide and a metal of the cathodic coloration transition metal oxide is reduced at the same time. For example, the cathodic coloration transition metal oxide includes tungsten oxide, molybdenum oxide, niobium oxide, titanium oxide, and the like.

The ion storage layer 122 may temporarily store electric charges escaping when bleaching occurs in the electrochromic layer 112. The ion storage layer 122 may be replaced with an anodic coloration transition metal oxide, which is an anodic coloration material, to increase light shielding rate of the electrochromic device 100. If the ion storage layer 122 is replaced with the anodic coloration transition metal oxide, when a voltage is applied to the electrochromic device 100, substituted the anodic coloration material and the cathodic coloration material of the electrochromic layer 112 may be colored simultaneously. Contrary to the cathodic coloration transition metal oxide, when a voltage is applied to the anodic coloration transition metal oxide, the anodic coloration transition metal oxide is a material that is colored as electrons and anions are inserted into the anodic coloration transition metal oxide, and the metal of the anodic coloration transition metal oxide is oxidized. For example, the anodic coloration transition metal oxide includes vanadium oxide, chromium oxide, iron oxide, manganese oxide, nickel oxide, rhodium oxide, iridium oxide, and the like.

If transparency of the electrochromic device 100 is required (for example, a smart window, etc.), both the first electrode layer 114 and the second electrode layer 124 must be transparent. For example, when external temperature is low, such as in winter, the window of the smart window should be transparent to transmit sunlight, but if the first electrode layer 114 and the second electrode layer 124 are opaque, the smart window is opaque and may not transmit sunlight even if the electrochromic layer is bleached.

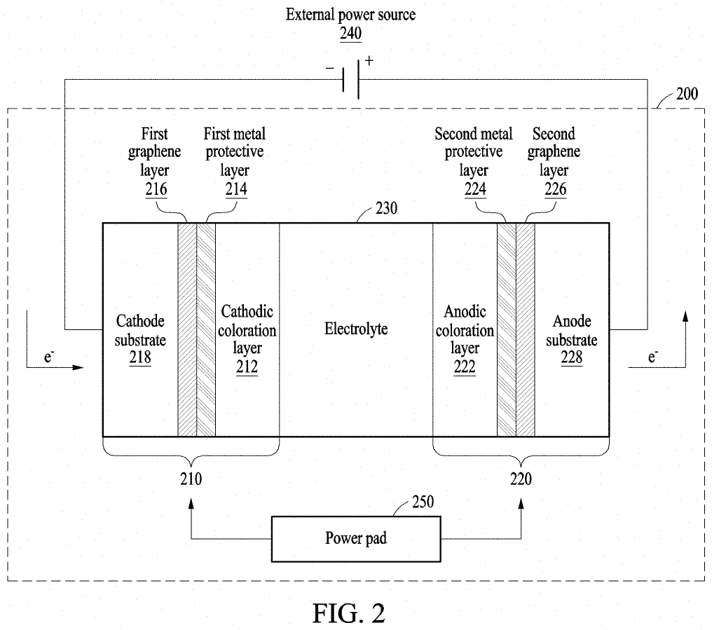

FIG. 2 is a diagram illustrating an electrochromic device according to various example embodiments.

Referring to FIG. 2, according to various example embodiments, an electrochromic device 200 may include a first multilayer thin film structure 210, a second multilayer thin film structure 220, an electrolyte 230, and a power pad 250. The first multilayer thin film structure 210 may be connected to a first electrode (for example, a cathode) of an external power source 240, and may contain a cathodic coloration layer 212, a first metal protective layer 214, and a first graphene layer 216, and a cathode substrate 218. The second multilayer thin film structure 220 may be connected to a second electrode (for example, an anode) of the external power source 240, and may include an anodic coloration layer 222, a second metal protective layer 224, and a second graphene layer 226, and an anode substrate 228.

According to various example embodiments, the cathode substrate 218 is connected to the first electrode (for example, the cathode) of the external power to source 240 and may be the lowermost lower layer of the first multilayer thin film structure. The anode substrate 228 may be opposite to the cathode substrate 218, and may be connected to the second electrode (for example, the anode) of the external power source 240 to be the lowermost lower layer of the second multilayer thin film structure. The cathode substrate 218 and the anode substrate 228 may be transparent substrates made of various materials such as glass, sapphire, plastic film, etc.

According to various example embodiments, the first graphene layer 216 may be formed (for example, coated or transferred) on the cathode substrate 218, and the second graphene layer 226 may be formed (for example, coated or transferred) on the anode substrate 228. The first graphene layer 216 and the second graphene layer 226 may be formed by transferring a single layer or a multilayer graphene film prepared by a chemical vapor deposition method onto a substrate. To reduce making cost of the electrochromic device 200, the first graphene layer 216 and the second graphene layer 226 may be prepared by applying reduced graphene oxide (rGO) flakes, which are prepared by reducing graphene oxide flakes, on a substrate by wet coating (for example, spin coating, bar coating, slot die coating, spray coating, etc.) method and by heat-treating them. To transfer or coat graphene on the cathode substrate 218 and the anode substrate 228, each of the cathode substrate 218 and the anode substrate 228 may be treated with a surface treatment process (for example, oxygen plasma treatment, UV irradiation, ozone treatment, etc.) before applying graphene.

According to various example embodiments, the first metal protective layer 214 may be formed on the first graphene layer 216, and the second metal protective layer 224 may be formed on the second graphene layer 226. The first metal protective layer 214 and the second metal protective layer 224 may be made with method including at least one of sputtering, thermal evaporation, chemical vapor deposition to (CVD), and atomic layer deposition (ALD). A process of forming of the first metal protective layer 214 and the second metal protective layer 224 is performed in a vacuum state or using an inert gas atmosphere to form the first metal protective layer 214 and the second metal protective layer 224. When the first metal protective layer 214 and the second metal protective layer 224 is formed, damage to the first graphene layer 216 and the second graphene layer 226 may be suppressed.

According to various example embodiments, the same metal as a part of a composition of the electrochromic layer (for example, the cathodic coloration layer 212 or the anodic coloration layer 222) may be used for the first metal protective layer 214 and the second metal protective layer 224, for process convenience. For example, in the case that tungsten oxide is used for the electrochromic layer and tungsten is used for the metal protective layer, since tungsten oxide and tungsten may be sequentially deposited on a graphene layer using the same target in one chamber using a sputtering method, process convenience may be increased. The metal protective layer may include one or more of silver, gold, platinum, copper, tungsten, molybdenum, niobium, titanium, vanadium, chromium, iron, manganese, nickel, rhodium, iridium, and aluminum. In the electrochromic device 200, to secure a high light transmittance and low sheet resistance, if a metal having relatively the high light transmittance (for example, silver, copper, etc.) is used for the metal protective layer, thickness of the metal protective layer may be limited to 30 nm or less, and if a metal having relatively a low light transmittance (for example, aluminum) is used for the metal protective layer, thickness of the metal protective layer may be limited to 10 nm or less.

According to various example embodiments, the cathodic coloration layer 212 may be formed on the first metal protective layer 214, and the anodic coloration layer 222 may be formed on the second metal protective layer 224. A cathodic coloration transition metal oxide (for example, tungsten oxide, molybdenum oxide, niobium oxide, titanium oxide, etc.) exhibiting electrochromic properties may be used for the cathodic coloration layer 212, and an anodic coloration transition metal oxide (for example, vanadium oxide, chromium oxide, iron oxide, manganese oxide, nickel oxide, rhodium oxide, iridium oxide, etc.) exhibiting electrochromic properties may be used for the anodic coloration layer 222. The cathodic coloration layer 212 and the anodic coloration layer 222 are formed by at least one of sputtering, thermal evaporation, chemical vapor deposition (CVD), atomic layer deposition (ALD), and heat treatment after wet coating or may be made by applying a solution containing fine particles of metal oxide constituting the cathodic coloration layer 212 and the anodic coloration layer 222 by wet coating (for example, spin coating, bar coating, slot die coating, spray coating) and then heat-treating them.

According to various example embodiments, the electrolyte 230 may be positioned between the first multilayer thin film structure 210 and the second multilayer thin film structure 220 to mediate movement of electric charges. The electrolyte 230 may be any one of a liquid and a solid. A separator in addition to the electrolyte 230 may be additionally installed between the first multilayer thin film structure 210 and the second multilayer thin film structure 220.

According to various example embodiments, the power pad 250 may connect the electrochromic device 200 to the external power source 240 and may have a sheet resistance of 10Ω/□ or less. The power pad 250 may be connected to the electrochromic device 200 at a position not in contact with the electrolyte 230. For example, the power pad 250 may be formed on a layer included in at least one of the first multilayer thin film structure 210 and the second multilayer thin film structure 220 (for example, the cathode substrate 218, the first graphene layer 216, the first metal protective layer 214, the cathodic coloration layer 212, the anode substrate 228, the second graphene layer 226, the second metal protective layer 224, and the anodic coloration layer 222).

According to various example embodiments, the electrochromic device 200 may improve impact resistance and form factor characteristics based on the first graphene layer 216 and the second graphene layer 226, and increase infrared transmittance and infrared region contrast ratio. Graphene is more flexible than a transparent conducting oxide (for example, indium tin oxide (ITO), etc.), unlike a transparent conducting oxide having low infrared transmittance, the light transmittance is high in infrared region, so that contrast ratio of infrared region may be increased. The electrochromic device 200 minimizes light reflection and absorption by a metal layer by limiting thickness of the first metal protective layer 214 and the second metal protective layer 224 to a maximum of 30 nm or less. A decrease in the light transmittance due to insertion of the first metal protective layer 214 and the second metal protective layer 224 may be minimized, and transparency and flexibility of the electrochromic device 200 may be maintained.

According to various example embodiments, the electrochromic device 200 may effectively protect each of the first graphene layer 216 and the second graphene layer 226 based on the first metal protective layer 214 and the second metal protective layer 224. In the case that an electrochromic device according to a related art (for example, the electrochromic device 100 of FIG. 1) uses graphene as the first electrode layer 114 or the second electrode layer 124, there may be restrictions in a process of making a thin film including the cathodic coloration transition metal oxide forming the electrochromic layer (for example, the electrochromic layer 112 in FIG. 1) and the anodic coloration transition metal oxide that replaces an ion storage layer (for example, the ion storage layer 122 in FIG. 1). As most of sputtering methods widely used for making a transition metal oxide thin film use oxygen together with argon (Ar) as a process gas, oxygen plasma may be generated during the process of making the transition metal oxide thin film. Oxygen plasma causes great damage to graphene, greatly increasing a sheet resistance, and as a result, at least one of the first electrode layer 114 or the second electrode layer 124 may become unable to function as an electrode. In addition, even in the case that the transition metal oxide thin film is formed on one or more of the first electrode layer 114 or the second electrode layer 124 by a wet coating process, due to a pretreatment process (for example, oxygen plasma treatment, UV ozone treatment, etc.) performed to lower surface energy of at least one of the first electrode layer 114 or the second electrode layer 124, since one or more of the first electrode layer 114 or the second electrode layer 124 may be greatly damaged, there may be significant limitations in the wet coating process. On the other hand, in the electrochromic device 200, since laminated multilayer thin film structure in which the first metal protective layer 214 is inserted between the first graphene layer 216 and the cathodic coloration layer 212, and the second metal protective layer 224 is inserted between the second graphene layer 226 and the anodic coloration layer 222 is used, it is possible to prevent damage to the first graphene layer 216 and the second graphene layer 226 that may occur during a process of forming metal oxide thin films of the cathodic coloration layer 212 and the anodic coloration layer 222. Even when using an atmosphere including oxygen such as oxygen plasma in the process of forming of the metal oxide thin films, the first metal protective layer 214 and the second metal protective layer 224 may protect the underlying first graphene layer 216 and second graphene layer 226. Thus, only upper surfaces of the first metal protective layer 214 and the second metal protective layer 224 may be oxidized, and the first graphene layer 216 and the second graphene layer 226 may not be damaged.

According to various example embodiments, a case in which a metal oxide used in the cathodic coloration layer 212 and the anodic coloration layer 222 of the electrochromic device 200 is tungsten oxide will be described in detail with examples. The cathode substrate 218 and the anode substrate 228 may be made of a polyethylene terephthalate (PET). The first graphene layer 216 and the second graphene layer 226 may be formed in five layers by a transfer process on each of the cathode substrate 218 and the anode substrate 228. The first metal protective layer 214 and the second metal protective layer 224 may be a 5 nm tungsten metal layer deposited on the first graphene layer 216 and the second graphene layer 226 using a DC sputtering process. A deposition of tungsten may be performed under the conditions of using a sputtering power of 100 W, a chamber pressure of 20 mTorr, and Ar gas (20 sccm flow rate) as a process gas. A deposition target is a tungsten metal target having a purity of 99.9% or more, and a base pressure of a chamber may be 5×10−⁵ Torr. The cathodic coloration layer 212 and the anodic coloration layer 222 may be a tungsten oxide layer deposited to a thickness of 300 nm on the tungsten metal layer using a sputtering process. A deposition of tungsten oxide may be performed under conditions of using a sputtering power of 100 W, a chamber pressure of 20 mTorr, and Ar gas (20 sccm flow rate) and O₂ gas (3 sccm flow rate) as process gases. The deposition target is the tungsten metal target having a purity of 99.9% or more, and a base pressure of a chamber may be 5×10−6 Torr.

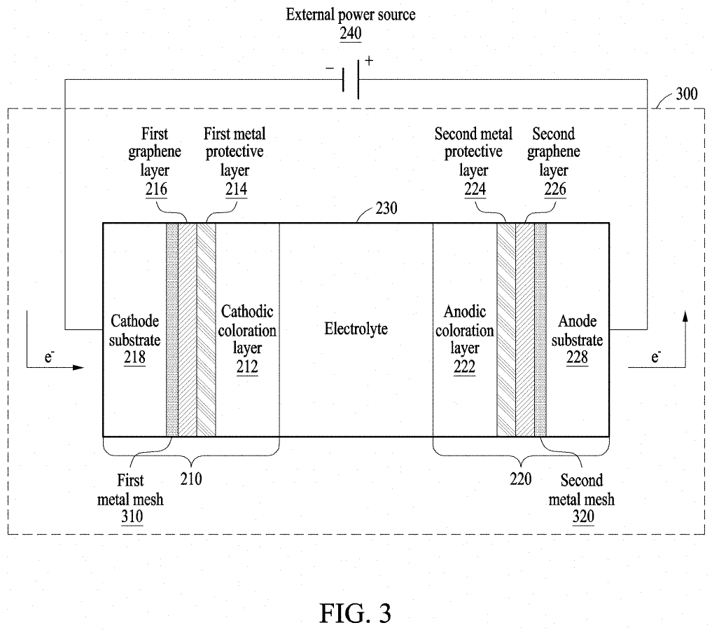

FIG. 3 is a diagram illustrating examples in which an electrochromic device is modified according to various example embodiments.

Referring to FIG. 3, according to various example embodiments, an electrochromic device 300 may include the cathodic coloration layer 212, the first metal protective layer 214, the first graphene layer 216, the cathode substrate 218, the anodic coloration layer 222, the second metal protective layer 224, the second graphene layer 226, the anode substrate 228, the electrolyte 230, and the power pad 250, described with reference to FIG. 2. The electrochromic device 300 may further include a first metal mesh 310 and a second metal mesh 320. The electrochromic device 300 may be one in which the first metal mesh 310 and the second metal mesh 320 are inserted under each of the first graphene layer 216 and the second graphene layer 226 shown in FIG. 2.

According to various example embodiments, in the electrochromic device 300, if a sheet resistance of the first graphene layer 216 is not sufficiently low, the first metal mesh 310 may be formed under the first graphene layer 216, if the sheet resistance of the second graphene layer 226 is not sufficiently low, the second metal mesh 320 may be formed under the second graphene layer 226. The first metal mesh 310 and the second metal mesh 320 may have a sheet resistance of 10Ω/□ or less. The electrochromic device 300 may significantly lower the sheet resistance while maintaining a high light transmittance based on at least one of the first metal mesh 310 and the second metal mesh 320.

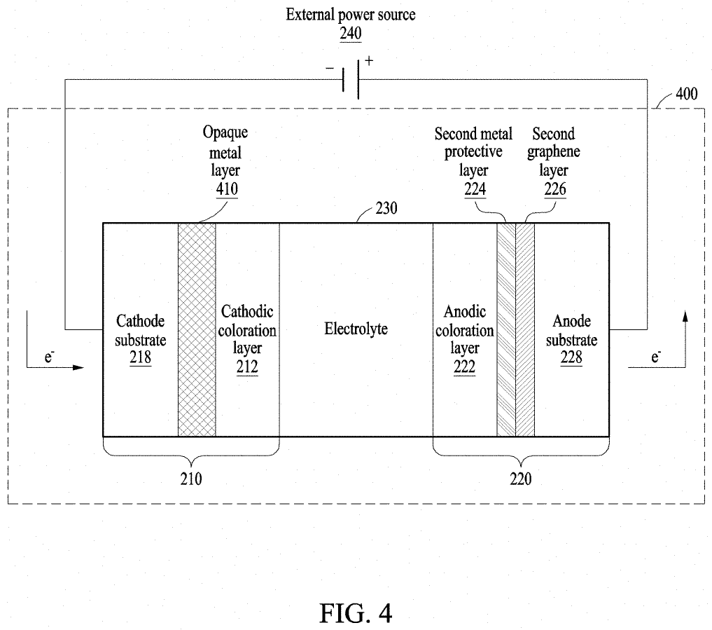

FIG. 4 is a diagram illustrating another example in which an electrochromic device is modified according to various example embodiments.

Referring to FIG. 4, according to various example embodiments, an electrochromic device 400 includes the cathodic coloration layer 212, the cathode substrate 218, the anodic coloration layer 222, and the anode substrate 228, the electrolyte 230, and the power pad 250 illustrated with reference to FIG. 2. The electrochromic device 400 may include the first metal protective layer 214 and the first graphene layer 216, or the second metal protective layer 224 and the second graphene layer 226 illustrated with reference to FIG. 2. The electrochromic device 400 may further include an opaque metal layer 410. In the electrochromic device 400, the first graphene layer 216 and the first metal protective layer 214, or the second graphene layer 226 and the second metal protective layer 224 shown in FIG. 2 may be replaced with the opaque metal layer 410. The opaque metal layer 410 may be an opaque metal. The electrochromic device 400 may be adjusted to have lower transparency than the electrochromic device 200 based on the opaque metal layer 410.

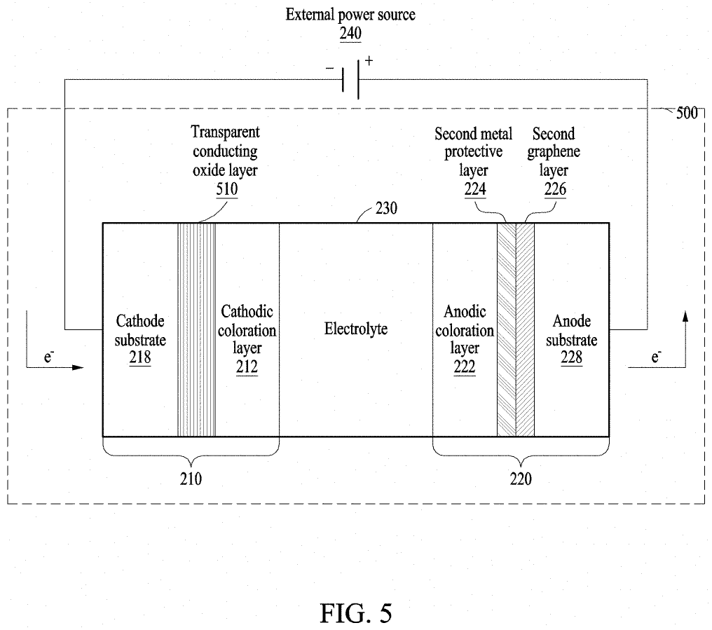

FIG. 5 is a diagram illustrating another example in which an electrochromic device is modified according to various example embodiments.

Referring to FIG. 5, according to various example embodiments, an electrochromic device 500 may include the cathodic coloration layer 212, the cathode substrate 218, the anodic coloration layer 222, the anode substrate 228, the electrolyte 230, and a power pad 250, illustrated with reference to FIG. 2. The electrochromic device 500 may include the first metal protective layer 214 and the first graphene layer 216 or the second metal protective layer 224 and the second graphene layer 226, illustrated with reference to FIG. 2. The electrochromic device 500 may further include a transparent conducting oxide (TCO) layer 510. In the electrochromic device 500, the first graphene layer 216 and the first metal protective layer 214, or the second graphene layer 226 and the second metal protective layer 224, shown in FIG. 2 may be replaced with the transparent conducting oxide (TCO) layer 510. Based on the transparent conducting oxide (TCO) layer 510, the electrochromic device 500 may be adjusted to have a lower infrared transmittance than the electrochromic device 200.

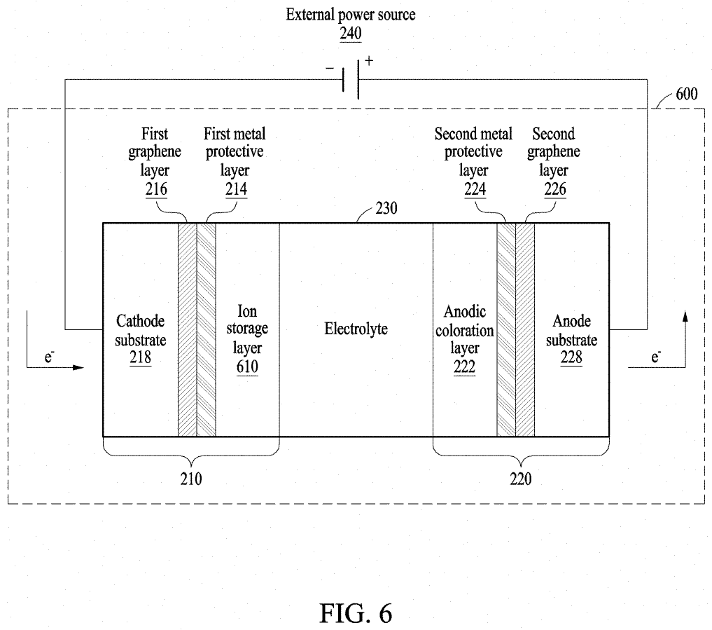

FIG. 6 is a diagram illustrating another example in which an electrochromic device is modified according to various example embodiments.

Referring to FIG. 6, according to various example embodiments, an electrochromic device 600 may include the first metal protective layer 214, the first graphene layer 216, the cathode substrate 218, the second metal protective layer 224, the second graphene layer 226, the anode substrate 228, the electrolyte 230, and the power pad 250, illustrated with reference to FIG. 2. The electrochromic device 600 may include a cathodic coloration layer 212 or an anodic coloration layer 222. The electrochromic device 600 may further include an ion storage layer 610. In the electrochromic device 600, the cathodic coloration layer 212 or the anodic coloration layer 222 shown in FIG. 2 may be replaced with the ion storage layer 610. The electrochromic device 600 may use the cathodic coloration layer 212 or the anodic coloration layer 222 as a colored or bleached layer, and the ion storage layer 610 may be used as a layer that only functions to store and supply electric charges.

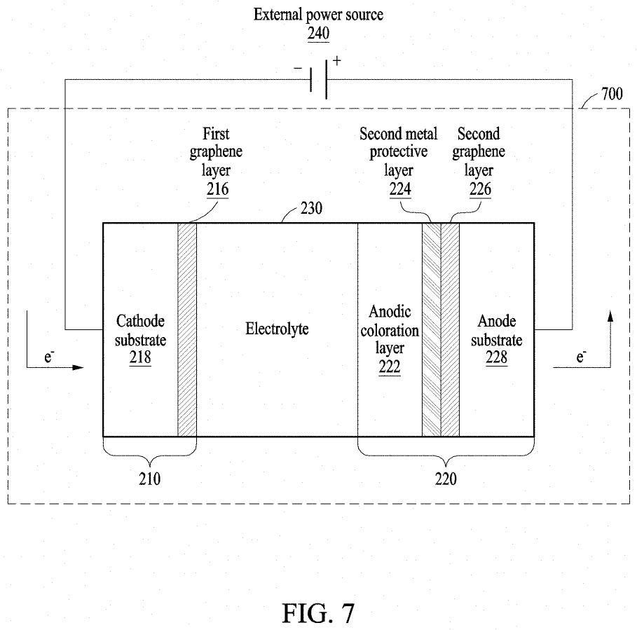

FIG. 7 is a diagram illustrating another example in which an electrochromic device is modified according to various example embodiments.

Referring to FIG. 7, according to various example embodiments, an electrochromic device 700 may include the first graphene layer 216, the cathode substrate 218, the second graphene layer 226, the anode substrate 228, the electrolyte 230, and the power pad 250, illustrated with reference to FIG. 2. The electrochromic device 700 may include a cathodic coloration layer 212 and a first metal protective layer 214, or an anodic coloration layer 222 and a second metal protective layer 224. The electrochromic device 700 may implement a device having a high light transmittance when bleached, by removing the cathodic coloration layer 212 and the first metal protective layer 214, or the anodic coloration layer 222 and the second metal protective layer 224 from the electrochromic device 200 shown in FIG. 2.

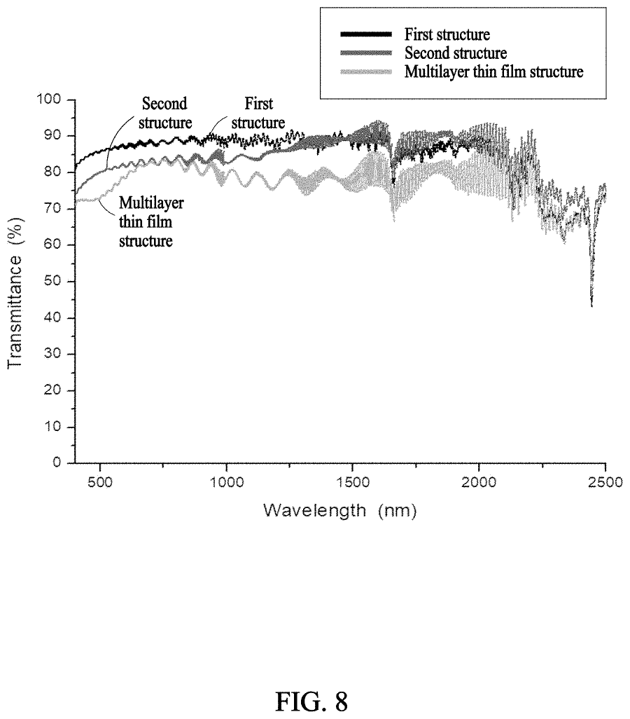

FIG. 8 is a diagram illustrating a light transmittance of the multilayer thin film structure shown in FIG. 2.

Referring to FIG. 8, according to various example embodiments, the light transmittance according to a wavelength of injected light of a multilayer thin film structure (for example, the first multilayer thin film structure 210 and the second multilayer thin film structure 220 of FIG. 2) may be compared with a light transmittance of other structures. A cathode substrate (for example, the cathode substrate 218 of FIG. 2), a first graphene layer (for example, the first graphene layer 216 of FIG. 2), a first metal protective layer (for example, the first metal protective layer 214 of FIG. 2), and a cathodic coloration layer (for example, the cathodic coloration layer 212 of FIG. 2) included in the multilayer thin film structure (for example, the first multilayer thin film structure 210 and the second multilayer thin film structure 220 of FIG. 2) may be a polyethylene terephthalate (PET) substrate, a five-layer graphene layer, a tungsten metal layer, and a tungsten oxide layer, respectively. A first structure to be compared with the multilayer thin film structure may be a single-layer structure made of only the PET substrate, and a second structure may be a substrate in which the five-layer graphene layer is formed (for example, coated) on the PET substrate.

According to various example embodiments, the light transmittance in the multilayer thin film structure may be the same as in the first structure and the second structure, or the multilayer thin film structure may exhibit a high light transmittance of 70% or more even if its light transmittance is smaller than those in the first structure and the second structure. In the case of the multilayer thin film structure, since a total of four layers are laminated, the light transmission may be a hindrance due to additional layers (for example, the tungsten metal layer and the tungsten oxide layer) compared to the first and second structures, but effect of lowering the light transmittance of the tungsten metal layer and the tungsten oxide layer may be small. For example, if the wavelength is 380 nm to 780 nm (for example, visible light region) and if the wavelength is 780 nm to 2500 nm (for example, infrared region), the light transmittance of the multilayer thin film structure may be excellent as 70% or more despite insertion of the tungsten metal layer and the tungsten oxide layer. A electrochromic device using the multilayer thin film structure (for example, the electrochromic device 200 of FIG. 2) may transmit more than 70% of infrared rays having the wavelength of 780 nm to 2500 nm, so it is possible to prevent a decrease in contrast ratio caused by infrared absorption of the electrochromic device 200.

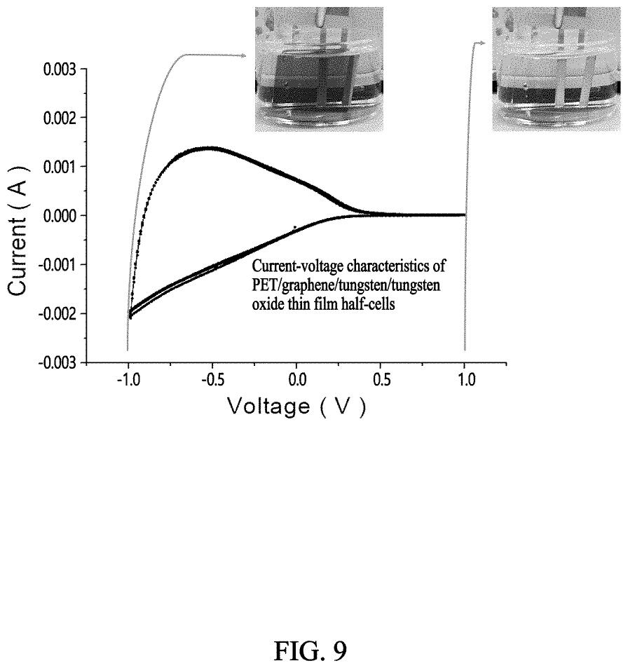

FIG. 9 is a diagram illustrating conductivity and electrochromic effect of the multilayer thin film structure shown in FIG. 2.

Referring to FIG. 9, according to various example embodiments, current-voltage characteristics of a multilayer thin film structure (for example, the first multilayer thin film structure 210 and the second multilayer thin film structure 220 of FIG. 2) using a half-cell system may be measured. A cathode substrate (for example, the cathode substrate 218 of FIG. 2), a first graphene layer (for example, the first graphene layer 216 of FIG. 2), a first metal protective layer (for example, the first metal protective layer 214 of FIG. 2), and a cathodic coloration layer (for example, the cathodic coloration layer 212 of FIG. 2) included in the multilayer thin film structure (for example, the first multilayer thin film structure 210 and the second multilayer thin film structure 220 of FIG. 2) may be a polyethylene terephthalate (PET) substrate, a five-layer graphene layer, a tungsten metal layer, and a tungsten oxide layer, respectively. An electrolyte used to form the half cell is 0.5 M LiClO4 in propylene carbonate, and a platinum rod may be used as a counter electrode. Silver paste may be applied to a multilayer thin film and the multilayer thin film may be connected to the external power source. According to the current-voltage characteristics of the multilayer thin film structure, it may be confirmed that electric charge injection is smooth at a cathodic voltage (for example, −1V) and electric charge discharge is smooth at an anodic voltage (for example, +1V). In addition, it may be confirmed that the multilayer thin film structure becomes opaque by coloring at the cathodic voltage (for example, −1V), and becomes transparent by bleaching at the anodic voltage (for example, +1V), so that an electrochromic effect is clearly implemented. With insertion of the tungsten layer, an electrochromic device using the multilayer thin film structure (for example, the electrochromic device 200 of FIG. 2) may transfer sufficient electric charges and almost no damage to graphene may occur in the process of forming the tungsten layer or the tungsten oxide layer, while maintaining transparency.

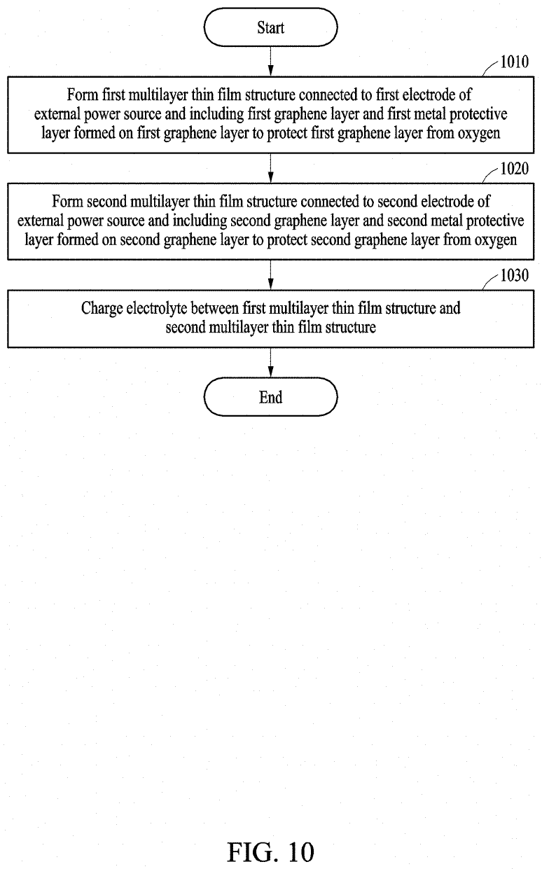

FIG. 10 is a flowchart of an example of a method of making an electrochromic device according to various example embodiments.

Referring to FIG. 10, according to various example embodiments, operations 1010 to 1030 may be for illustrating a process of forming an electrochromic device (for example, the electrochromic device 200 of FIG. 2) in which the electrochromic device includes graphene electrodes.

In operation 1010, the electrochromic device 200 may include a first multilayer thin film (for example, the first multilayer thin film structure 210 of FIG. 2). The first multilayer thin film structure 210 is connected to a first electrode (for example, a cathode) of an external power source (for example, the external power source 240 of FIG. 2), and may include a first graphene layer (for example, the first graphene layer 216 of FIG. 2) and a first metal protective layer (for example, the first metal protective layer 214 of FIG. 2) formed on the first graphene layer 216 to protect the first graphene layer 216 from oxygen.

In operation 1020, the electrochromic device 200 may include a second multilayer thin film (for example, the second multilayer thin film structure 220 of FIG. 2). The second multilayer thin film structure 220 is connected to a second electrode (for example, an anode) of the external power source, and may include a second graphene layer (for example, the second graphene layer 226 in FIG. 2) and a second metal protective layer (for example, the second metal protective layer 224 of FIG. 2) formed on the second graphene layer 226 to protect the second graphene layer 226 from oxygen.

In operation 1030, an electrolyte 230 may be charged between the first multilayer thin film structure 210 and the second multilayer thin film structure 220.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

As described above, although example embodiments have been illustrated with reference to limited drawings, those of skilled in the art may apply various technical modifications and variations based thereon. For example, even if described techniques are performed in a different order from the described methods, and/or components of the described systems, structures, devices, circuits, etc. are connected or combined in a manner different from the described methods, or replaced or substituted by other components or equivalents, suitable results may be achieved. Therefore, other implementations, other example embodiments, and equivalents to claims are also within the scope of the following claims.

What is claimed is:

1. An electrochromic device comprising:
a first multilayer thin film structure connected to a first electrode of an external power source and comprising a first graphene layer and a first metal protective layer formed on the first graphene layer to protect the first graphene layer from oxygen;
a second multilayer thin film structure connected to a second electrode of the external power source and comprising a second graphene layer and a second metal protective layer formed on the second graphene layer to protect the second graphene layer from oxygen; and
an electrolyte charged between the first multilayer thin film structure and the second multilayer thin film structure.

2. The electrochromic device of claim 1, wherein the first multilayer thin film structure further comprises:
a cathode substrate connected to the first electrode of the external power source and positioned under the first graphene layer; and
a cathodic coloration layer formed on the first metal protective layer.

3. The electrochromic device of claim 2, wherein the second multilayer thin film structure further comprises:
an anode substrate connected to the second electrode of the external power source and positioned under the second graphene layer; and
an anodic coloration layer formed on the second metal protective layer.

4. The electrochromic device of claim 3, wherein the first metal protective layer comprises a metal of the same component as a part of composition of the cathodic coloration layer, and the second metal protective layer comprises a metal of the same component as a part of composition of the anodic coloration layer.

5. The electrochromic device of claim 3, wherein each of the first multilayer thin film structure and the second multilayer thin film structure further comprises a metal mesh having a sheet resistance of 10Ω/□ or less formed under each of the first graphene layer and under the second graphene layer.

6. The electrochromic device of claim 3, wherein the first graphene layer and the first metal protective layer are replaced with an opaque metal, or the second graphene layer and the second metal protective layer are replaced with an opaque metal.

7. The electrochromic device of claim 3, wherein the first graphene layer and the first metal protective layer are replaced with a transparent conducting oxide (TCO) layer, or the second graphene layer and the second metal protective layer are replaced with a TCO layer.

8. The electrochromic device of claim 3, wherein one of the cathodic coloration layer and the anodic coloration layer is replaced with an ion storage layer.

9. The electrochromic device of claim 3, wherein the cathodic coloration layer and the first metal protective layer are removed, or the anodic coloration layer and the second metal protective layer are removed.

10. A method of making an electrochromic device using a multilayer thin film structure comprising a graphene layer, the method comprising:
forming a first multilayer thin film structure connected to a first electrode of an external power source and comprising a first graphene layer and a first metal protective layer formed on the first graphene layer to protect the first graphene layer;
forming a second multilayer thin film structure connected to a second electrode of the external power source and comprising a second graphene layer and a second metal protective layer formed on the second graphene layer to protect the second graphene layer; and
charging an electrolyte between the first multilayer thin film structure and the second multilayer thin film structure.

11. The method of claim 10, wherein the forming of the first multilayer thin film structure comprises:
forming the first graphene layer on a cathode substrate connected to the first electrode;
forming the first metal protective layer on the first graphene layer using one or more of sputtering, thermal deposition, chemical vapor deposition, and atomic layer deposition; and
forming a cathodic coloration layer comprising a metal oxide on the first metal protective layer using one or more of sputtering, thermal deposition, chemical vapor deposition, atomic layer deposition, and heat treatment after wet coating.

12. The method of claim 11, wherein the forming of the second multilayer thin film structure comprises:
forming the second graphene layer on an anode substrate opposite the cathode substrate and connected to the second electrode;
forming the second metal protective layer on the second graphene layer using one or more of sputtering, thermal deposition, chemical vapor deposition, and atomic layer deposition; and
forming an anodic coloration layer comprising a metal oxide on the second metal protective layer using one or more of sputtering, thermal deposition, chemical vapor deposition, atomic layer deposition, and heat treatment after wet coating.

13. The method of claim 12, further comprising:
forming a metal mesh having a sheet resistance of 10Ω/□ or less formed under each of the first graphene layer and the second graphene layer.

14. The method of claim 12, wherein the first graphene layer and the first metal protective layer are replaced with an opaque metal, or the second graphene layer and the second metal protective layer are replaced with an opaque metal.

15. The method of claim 12, wherein the first graphene layer and the first metal protective layer are replaced with a transparent conducting oxide (TCO) layer, or the second graphene layer and the second metal protective layer are replaced with a TCO layer.

16. The method of claim 12, wherein one of the cathodic coloration layer and the anodic coloration layer is replaced with an ion storage layer.
